(19) United States
(12) Patent Application Publication
(10) Pub. No.: US 2026/0249239 A1
(43) Pub. Date: Aug. 27, 2026

(54) CARBON DIOXIDE CAPTURE SYSTEM FOR MOTOR-VEHICLE

(71) Applicant: C.R.F. Società Consortile per Azioni, Orbassano (IT)

(72) Inventors: Giorgio Luigi MASOERO, Orbassano (IT); Fabrizio MATTIELLO, Orbassano (IT); Luca STOLCIS, Torino (IT); Frank JORDAN, Torino (IT)

(73) Assignee: C.R.F. Società Consortile per Azioni, Orbassano (IT)

(21) Appl. No.: 19/160,378

(22) PCT Filed: Jan. 19, 2024
(86) PCT No.: PCT/IB2024/050517

§ 371 Date: Aug. 27, 2025

(30) Foreign Application Priority Data
Feb. 27, 2023 (IT) 102023000003438

(51) Int. Cl. B01D 53/62; B01D 53/82

(52) U.S. Cl. CPC B01D 53/62; B01D 53/82; B01D 2251/302; B01D 2251/304; B01D 2251/404; B01D 2251/602; B01D 2251/604; B01D 2257/504; B01D 2258/06; B01D 2259/4566

(57) ABSTRACT

A carbon dioxide capture system for a motor-vehicle is arranged to remove carbon dioxide from the atmosphere when the vehicle is in motion. The system has a carbon dioxide capture module mounted on a wheel arch of the vehicle, wherein the capture module includes an adsorbent cartridge made of adsorbent material suitable for retaining carbon dioxide, and a hollow casing containing the cartridge. The hollow casing has at least one inlet opening for the entry of an airflow into the casing, to be treated with the cartridge, and at least one outlet opening for releasing carbon dioxide-free air.

### FIELD OF THE INVENTION

The present invention concerns a carbon dioxide (also known as carbonic anhydride) capture system for a motor-vehicle. The invention finds particular, although not limiting, application in the field of electric propulsion vehicles, with the aim of providing a motor-vehicle with negative carbon dioxide emissions.

### PRIOR ART

Various solutions of the type indicated above have already been proposed in the past, in order to reduce the polluting emissions of a vehicle, in particular by means of carbon dioxide adsorbent devices. For example, WO 2017 212 381 illustrates an air purifying system for vehicle, having a carbon dioxide capture device (also called a carbon dioxide scrubber) integrated into the exhaust system of the vehicle.

However, the solutions known to date are not fully satisfactory from several points of view, including the high complexity with consequent high development costs, as well as the need to implement the system on a vehicle with totally electric propulsion.

### OBJECT OF THE INVENTION

The object of the present invention is to overcome the drawbacks of the solutions known to date, providing a system totally compatible with a totally electric propulsion vehicle.

In particular, an object of the present invention is to provide a carbon dioxide capture system for motor-vehicle, which is extremely simple and inexpensive to achieved.

A further object of the present invention is to provide a system of the type indicated above which minimizes the complexity of the maintenance operations to be carried out periodically on the system components.

### SUMMARY OF THE INVENTION

According to one or more embodiments, one or more of the above-mentioned objects are achieved through a carbon dioxide capture system for a motor-vehicle, having the features set out in the attached claims.

In particular, the invention has as its object a carbon dioxide capture system for motor-vehicle, arranged to remove carbon dioxide from the atmosphere when the vehicle is in motion, comprising:
a vehicle wheel arch forming an arched shaped body prevalently spaced around the rotation axis of the relative wheel,
at least one carbon dioxide capture module mounted on said wheel arch,
wherein said capture module comprises an adsorbent cartridge made of adsorbent material suitable for retaining carbon dioxide, and a hollow casing containing said cartridge,
wherein said hollow casing comprises at least one inlet opening for the entry of an airflow into the casing, to be treated with the cartridge, and at least one outlet opening for releasing carbon dioxide-free air.

Further preferred features of the invention are described in the attached claims and in the following description.

### BRIEF DESCRIPTION OF THE FIGURES

Further features and advantages of the invention will emerge from the following description with reference to the attached drawings, provided purely by way of non-limiting example, wherein:

FIG. 1 is a partial cross-sectional side view illustrating a preferred embodiment of a carbon dioxide capture system mounted on a wheel arch of the vehicle,

FIG. 2 is a partially exploded perspective view of the system illustrated in the previous figure,

FIG. 3 is a perspective view of a carbon dioxide capture module comprising an adsorbent cartridge,

FIG. 4 is a partial cross-sectional view of the module of the previous figure in the assembled configuration,

FIG. 5 is an enlarged scale view of further features of the system illustrated in FIGS. 1, 2.

### DETAILED DESCRIPTION OF MULTIPLE EMBODIMENTS

The following description illustrates various specific details aimed at an in-depth understanding of examples of one or more embodiments. The embodiments can be achieved without one or more of the specific details, or with other methods, components, materials, etc. In other cases, known structures, materials or operations are not shown or described in detail to avoid obscuring various aspects of the embodiments. The reference to “an/one embodiment” in this description is to indicate that a particular configuration, structure or feature described in connection with the embodiment is comprised in at least one embodiment. Therefore, phrases such as “in an/one embodiment”, possibly present in different places in this description, do not necessarily refer to the same embodiment. Furthermore, particular conformations, structures or features can be combined appropriately in one or more embodiments and/or associated with the embodiments in a different way from as illustrated here, so for example a feature exemplified here in relation to a figure it may be applied to one or more embodiments exemplified in a different figure.

The references illustrated here are for convenience only and therefore do not limit the extent of protection or the scope of the embodiments.

In the attached drawings, the reference 1 generally indicates a carbon dioxide capture system for a motor-vehicle, capable of capturing carbon dioxide from the atmosphere during use of the motor-vehicle, in an area close to system 1.

According to the present invention, the capture system 1 comprises a carbon dioxide capture module 2 mounted on at least one of the wheel arches 3 of the vehicle, preferably on the wheel arches of the front wheels of the motor-vehicle. As it is known, a wheel arch 3 is a component of the vehicle bodywork, generally arched in shape, which delimits a space in the bodywork having the function of containing and covering one of the wheels W of the vehicle. Being positioned in the wheel arch 3, the carbon dioxide capture module 2 advantageously exploits the aerodynamic effects caused by the apparent airflow hitting the vehicle, as well as those caused by the swirling airflow generated by the rapid rotation of the wheel W. Therefore, module 2 is mounted in an area of the vehicle where the air pressure is higher than the ambient atmospheric pressure. This positioning of the capture module 2 is also advantageous since it allows the entire layout of the components of the system 1 along the wheel arch 3 to be rationalized and optimized.

The wheel arch 3 can be made, for example, from a shaped body of metal or plastic sheet, which comprises at least one band which develops mainly in an arc around the rotation axis of the relative wheel W, so as to present an concave intrados 4 designed to define a portion of the outer surface of the bodywork and facing radially towards the wheel W, and an opposite convex extrados 5 facing the inside of the bodywork.

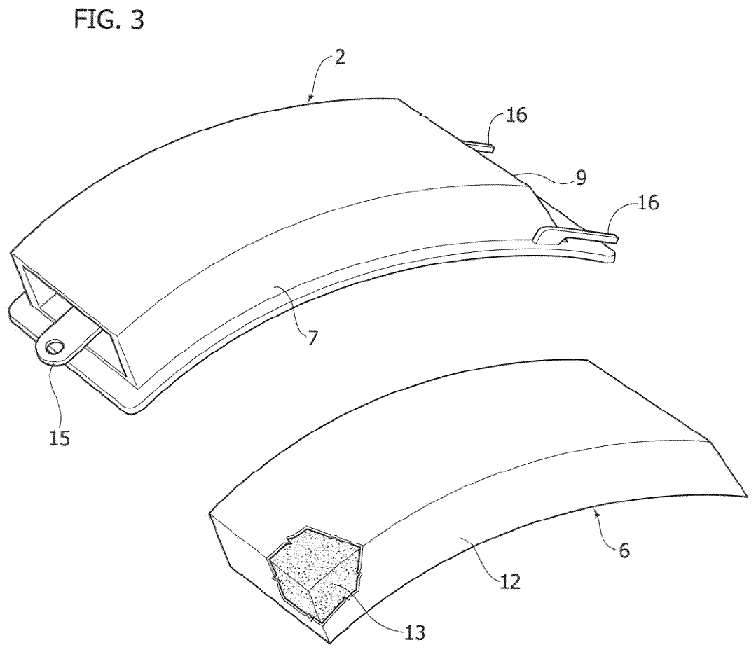

With particular reference to FIG. 3, the module 2 comprises an adsorbent cartridge 6 made of adsorbent material suitable for retaining carbon dioxide, and a hollow casing 7 containing said cartridge 6. The casing 7 and the cartridge 6 are also made with generally arched shapes for the positioning along the wheel arch 3, where it has been found that an effective overpressure zone is normally present.

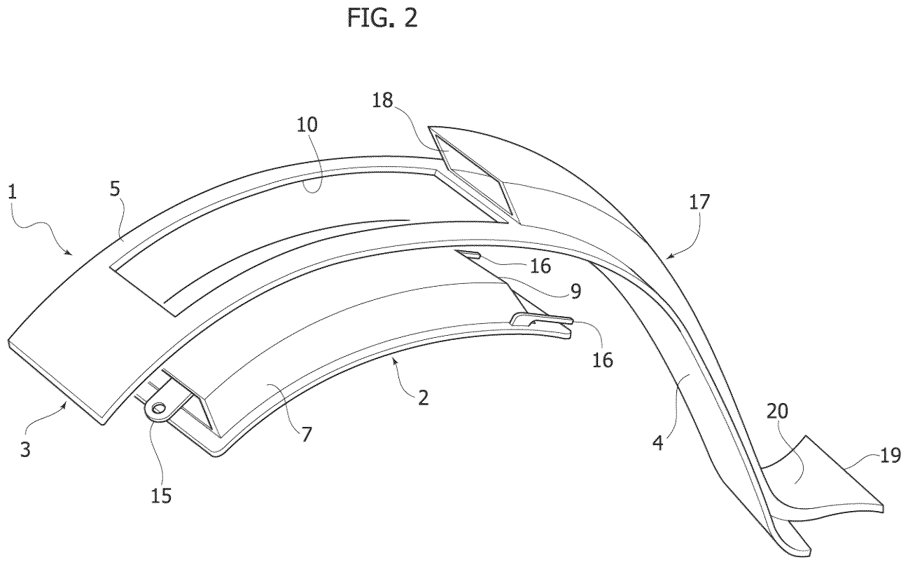

With reference to the assembled configuration on the wheel arch, the casing 7 comprises a lower wall facing the wheel W of the vehicle, an upper wall opposite the lower wall, two opposite side walls extending substantially along the longitudinal direction of the vehicle, a substantially transverse front wall and which joins opposite side walls, and a rear wall opposite to the front wall. In the assembled configuration, the casing 7 is connected to the wheel arch 3 and is arranged within a compartment 10 formed along the arched band forming the wheel arch 3, so that the lower wall of the casing 7 is aligned with the intrados 4 of the wheel arch 3 (FIG. 2).

According to the illustrated embodiment, the casing 7 and the cartridge 6 have an overall trapezoidal prism shape, with main surfaces of an arcuate shape to follow the line of the wheel arch 3. Of course, the cartridge 6 is smaller in size than the casing 7 to allow its positioning inside the hollow casing. In a preferred embodiment, the compartment 10 to accommodate the module 2 is formed along a front area of the wheel arch 3 (with reference to the configuration mounted on the vehicle), substantially up to the upper point of the arch defined by the wheel arch 3. Beyond the upper point, the wheel arch 3 extends substantially up to the vehicle chassis. In other embodiments, the compartment 10 for receiving the module 2 extends beyond the upper point of the wheel arch 3.

The external casing 7 comprises at least one inlet opening 8 for entry of an airflow into the casing 7, to be treated with the cartridge 6, and at least one outlet opening 9 for releasing carbon dioxide-free air. Since the module 2 is installed in an overpressure area, when the vehicle is moving, the air is sucked into the casing 7, to be treated with the cartridge 6 which captures the carbon dioxide. Of course, the general configuration of the inlet and outlet openings 8,9, as well as the shape of the cartridge 5 are arranged to ensure that the incoming airflow, before exiting the hollow casing 7, hits the body of the cartridge 6, maximizing the effectiveness of the carbon dioxide capture action.

In a preferred embodiment, as illustrated in FIGS. 3,4, the inlet opening 8 is made by a plurality of slits 11 placed side by side and spaced transversally along said lower wall of the hollow casing 7.

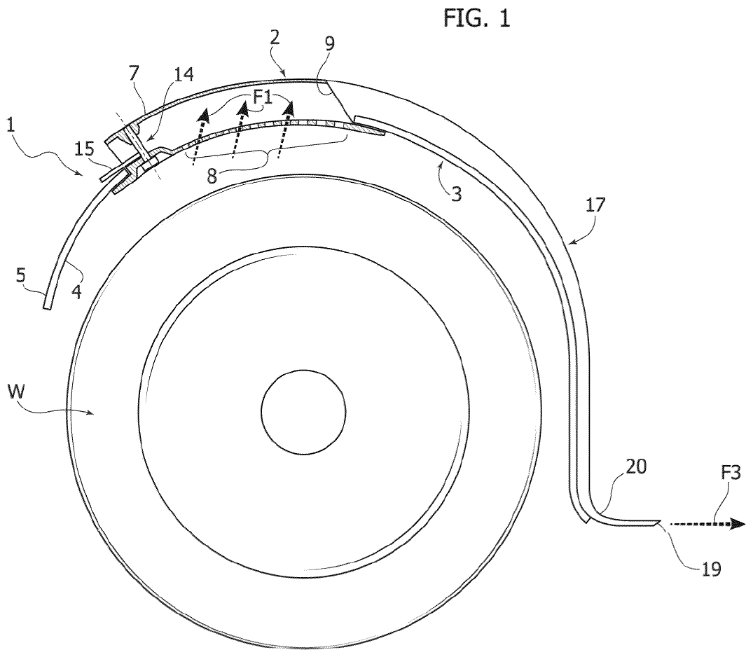

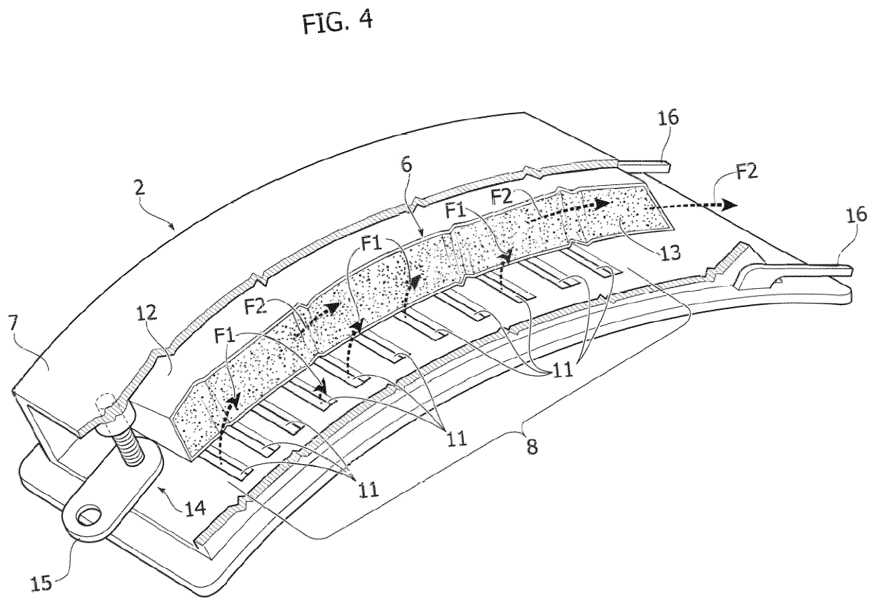

Preferably, the slits 11 have a substantially straight conformation, elongated along the entire width of the casing 7, and a spacing spaced at a constant pitch with respect to each other, along the lower wall of the casing 7. By means of this configuration, the overpressured air is sucked into the casing 7 through the slits 11, as indicated in the arrows F1 of FIGS. 1, 4. The airflow then hits the body of the cartridge 6 arranged inside the hollow casing 7, up to the outlet opening 9. As illustrated in particular in FIG. 3, the outlet opening 9 is formed along the rear wall of the hollow casing 7.

Therefore, with the vehicle in motion, the air enters the hollow casing 7 through the slits 11 arranged in the overpressure area. The carbon dioxide remains trapped inside the cartridge 6 and the air flows through the outlet port 9.

Looking in particular at the exploded view of FIG. 3, the cartridge 6 comprises an outer surface 12 of transpiring and air-permeable material, inside which there is a body of adsorbent material 13 suitable for retaining carbon dioxide. Preferably, the body of adsorbent material 13 is made of grains of lithium hydroxide (LiOH) or soda lime, or other substances as long as they are suitable for the intended purpose.

According to a further feature of the invention, the module 2 containing the cartridge 6 is removably connected to the wheel arch 3 by means of fastening means 14 configured for enabling picking up of the module 2 to proceed with the maintenance operations and/or replacement of the cartridge.

In fact, it should be noted that the adsorbent cartridge 6 is designed to dispose of a certain quantity of carbon dioxide up to a level of total saturation, beyond which it is no longer able to perform the adsorption function. Therefore, during the life of the vehicle, once saturation has been reached, the cartridge 6 must be replaced with a new cartridge ready for use, or be regenerated using regeneration processes known in the technological sector in question, before being installed again on board the vehicle.

In this regard, in one or more embodiments, the cartridge 6 can be extracted from the exit port 9 or from an access port (not shown) formed along the upper wall of the casing 7.

Once the cartridge 6 has been replaced, once the module 2 has been placed inside the compartment 10, the fastening means 14 can be operated manually to fasten the module 2 again to the wheel arch 3.

In one or more embodiments, the fastening means 14 comprise fastening members associated with a front part and a rear part of the casing 7, for mutual engagement with corresponding portions of the wheel arch 3, after having positioned the module 2 within the compartment 10. With reference to FIG. 1, the front fastening member comprises an engagement tab 15 rotatably mounted on a front portion of the casing 7, between a protruding position, suitable for engaging with the wheel arch 3 in particular above the extrados 5 (FIG. 1), and a rotated position suitable for freeing the front portion of the casing 7 from the corresponding front portion of the wheel arch 3. With reference to FIG. 3, the rear fastening member comprises a pair of engaging levers 16 arranged for mutual engagement with the extrados 5 of the wheel arch 3 at a rear portion of the compartment 10. According to the illustrated embodiment, the pair of levers 16 is provided on opposite sides of the casing 7, at a rear area of the casing 7 wherein said outlet opening 9 is provided. Of course, the fastening means 14 for removably engaging the module 2 to the wheel arch 3 can be made in different ways compared to what has been described and shown, provided they are suitable to allow a reliable rigid connection on the wheel arch 3 and at the same time allow the removal of the module 2 for proceeding with replacing the cartridge 6.

According to a further feature of the invention, the capture system 1 comprises an aerodynamic diffuser 17 in fluid communication with the outlet opening 9 of the carbon dioxide capture module 2. The diffuser 17 forms a channel configured to convey and discharge into the environment the carbon dioxide-free airflow coming from the casing 7, after having hit the cartridge 6.

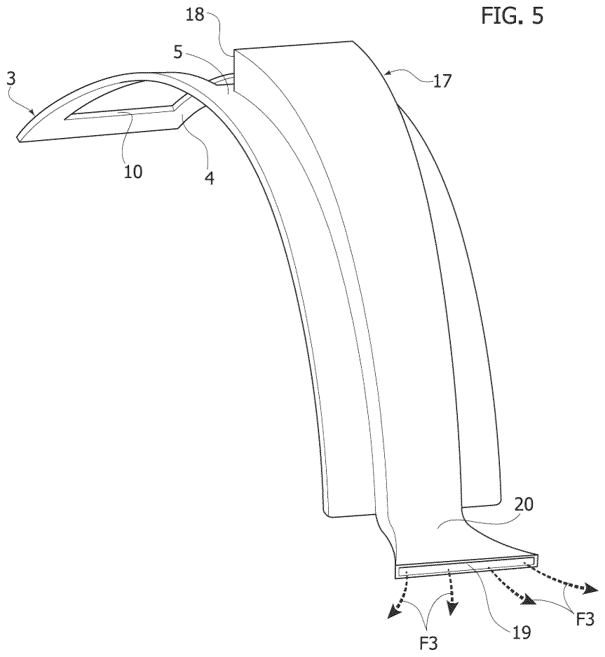

As illustrated in the attached drawings, in particular in FIG. 5, the diffuser 17 comprises an inlet port 18 and an outlet port 19, and is spaced along the wheel arch 3, in particular above the extrados 5, behind the module 2. In the assembled configuration, the outlet opening 9 of the module 2 and the inlet port 18 of the diffuser 17 are spaced consecutively along the wheel arch 3, substantially presenting the same dimensions. To minimize air leaks, a gasket is mounted along the edge defining the outlet opening 9 and is in contact with the front surface of the inlet port 18.

As indicated previously, the diffuser 17 is configured to convey and discharge the carbon dioxide-free airflow coming from the outlet opening 9 into the environment. More specifically, the diffuser 17 is arranged to produce an exiting pressure reduction, thus increasing the pressure difference between inlet and outlet in order to optimize the flow rate and efficiency of the system 1. The diffuser 17 extends above and along the extrados 5 of the wheel arch 3, from the outlet opening 9 of the casing 7, up to the rear end of the wheel arch 3.

As illustrated in FIGS. 1,2,5, the end part of the diffuser 17 comprises an outlet 20 having the outlet port 19. Preferably, the diffuser 17 has a substantially S-shaped general conformation with the inlet port 19 in proximity of the upper point of the wheel arch, and the outlet 20 which extends horizontally beyond the wheel arch 3 and under the vehicle chassis, optimizing the discharge of the exiting carbon dioxide-free flow. In this regard, note that the outlet 20 is a port divergent with respect to the width of the channel extended between the inlet port 18 and the outlet port 19.

During operation, in the overpressure area that is generated during the movement of the vehicle, the air enters the cartridge 6 through the slits 11 of the casing 7 (arrows F1 in FIGS. 1, 4). The airflow passes through the cartridge 6 (arrows F2 in FIG. 4) and exits through the diffuser 17 in an area with lower pressure than that in the inlet area (arrows F3 in FIGS. 1, 5).

Preferably, by providing the diffuser 17 along the wheel arch 3, it is also advantageously possible to create a single structural component of the vehicle which incorporates the wheel arch 3 and the aerodynamic diffuser 17 in fluid communication with the outlet opening 9 of the module 2.

Note that the present invention achieves further advantageous effects, even when the cartridge 6 is now saturated and is no longer able to dispose of quantities of carbon dioxide present in the air entering the casing 7, in particular:
sound-absorbing effect of airborne noise generated in the wheel well, depending on the size of the module;
improvement of the general aerodynamics of the wheel arch with reduction of aerodynamic resistance.

In one or more embodiments, the system 1 is implemented on all the wheel arches 3 of the vehicle,

In one or more embodiments, the system 1 further comprises sensor means (not shown) configured to warn the user, for example by means of an illuminated warning light on the instrument panel of the vehicle, of the reaching of the saturation level of the cartridge 6. In this way, the user will be promptly notified that the cartridge 6 must be regenerated and therefore replaced.

In one or more embodiments, the system 1 also comprises further sensor means (not shown) suitable for warning the user of any mud residues or foreign bodies that close the inlet opening 9 of the module 2, so as to be able to proceed with washing the vehicle and/or free the inlet opening 9 to allow full functionality of the system 1.

Of course, notwithstanding the principle of the invention, the construction details and the embodiments may vary widely with respect to what has been described and illustrated purely by way of example, without thereby departing from the scope of the present invention as defined in the attached claims.

1. Carbon dioxide capture system for motor-vehicle, arranged to remove carbon dioxide from the atmosphere when the vehicle is in motion, comprising:
a vehicle wheel arch forming an arched shaped body prevalently spaced around a rotation axis of a relative wheel,
at least one carbon dioxide capture module mounted on said wheel arch,
wherein said capture module comprises an adsorbent cartridge made of adsorbent material suitable for retaining carbon dioxide, and a hollow casing containing said cartridge,
wherein said hollow casing comprises at least one inlet opening for the entry of an airflow into the casing, to be treated with the cartridge, and at least one outlet opening for releasing carbon dioxide-free air.

2. System according to claim 1, wherein the casing and the cartridge are made with generally arched shapes for the positioning along the wheel arch, at an effective overpressure zone of the vehicle, in the assembled configuration.

3. System according to claim 2, wherein the casing is connected to the wheel arch and is arranged within a compartment formed along the arched shaped body forming the wheel arch, so that, in the assembled configuration, a lower wall of the casing facing the wheel is aligned with an intrados surface of the wheel arch.

4. System according to claim 3, wherein the inlet opening is made by a plurality of slits placed side by side and spaced transversally along the lower wall of the hollow casing.

5. System (1) according to claim 1, wherein the outlet opening is formed along a rear wall of the hollow casing, to let flow out the airflow treated by the cartridge.

6. System according to claim 1, wherein the cartridge comprises an outer surface of transpiring and air-permeable material, inside which there is a body of adsorbent material suitable for retaining carbon dioxide.

7. System (1) according to claim 1, wherein the module is removably connected to the wheel arch by means of fastening means configured for enabling picking up of the module and proceeding with replacing the cartridge.

8. System according to claim 1, comprising an aerodynamic diffuser in fluid communication with the outlet opening, extended along the wheel arch behind the module.

9. System according to claim 8, wherein the aerodynamic diffuser comprises an outlet extending beyond the wheel arch and under the vehicle floor, in the assembled configuration.

10. System according to claim 8, wherein the wheel arch and the aerodynamic diffuser are made in a single structural component.

11. Motor-vehicle comprising at least one system according claim 1.
